(19) United States
(12) Patent Application Publication
(10) Pub. No.: US 2020/0327556 A1
(43) Pub. Date: Oct. 15, 2020

(54) METHOD TO ACCEPT CERTIFICATIONS WITH BLOCKCHAIN TRANSACTIONS

(71) Applicant: salesforce.com, inc., San Francisco, CA (US)

(72) Inventors: Jeff Lin Wang, San Francisco, CA (US); George Lim, Fremont, CA (US); Jiaxiang Chen, Pittsburgh, CA (US)

(21) Appl. No.: 16/399,889

(22) Filed: Apr. 30, 2019

Related U.S. Application Data
(60) Provisional application No. 62/833,591, filed on Apr. 12, 2019.

(51) Int. Cl. G06Q 30/00; H04L 9/06; H04L 9/32; G06Q 20/36

(52) U.S. Cl. CPC G06Q 30/018; H04L 9/0637; H04L 2209/38; H04L 9/3268; G06Q 20/363; H04L 9/3213

(57) ABSTRACT

A method by a network device to record certifications granted to users in a distributed ledger implemented by a peer-to-peer computer network. The method includes responsive to determining that a second certification has been granted to a user after the first certification has been granted to the user, causing a token transfer to be recorded in the distributed ledger between a digital wallet associated with the second certification and a digital wallet associated with the user to indicate that the second certification has been granted to the user and also causing a token transfer to be recorded in the distributed ledger between a digital wallet associated with the first certification and the digital wallet associated with the second certification to indicate that the second certification has been granted to the user after the first certification.

### CROSS-REFERENCE TO RELATED APPLICATIONS

This application claims the benefit of U.S. Provisional Application No. 62/833,591, filed Apr. 12, 2019, which is hereby incorporated by reference.

### TECHNICAL FIELD

One or more implementations relate to the field of computer networks, and more specifically to storing records of certifications granted to users in a distributed ledger implemented in a peer-to-peer computer network.

### BACKGROUND ART

A blockchain is a continuously expanding set of blocks that are linked and secured using cryptography. In particular, every block in a blockchain may include a cryptographic hash of the immediately preceding block, a timestamp for the current block, and transaction data. A blockchain may be shared and managed through a peer-to-peer computer network, where peers verify/validate new blocks to be added to the blockchain such that a block in a blockchain cannot be altered without alteration of all subsequent blocks, which requires network consensus. This architecture allows for security of information stored within blocks through the use of cryptography; sharing/distribution of information through the use of peer-to-peer networks; trust through the use of consensus of block addition; and immutability of information stored within blocks through the use of cryptography, chaining/linking of blocks, and peer distribution (e.g., each peer in the network may maintain a ledger of all verified/validated transactions in the network).

Certification authorities may grant certifications to users who have demonstrated to possess a certain level of knowledge and/or skill usually by completing a course and/or passing an examination. Each certification authority is typically responsible for storing records of the certifications that it has granted to users in its own database, which may or may not be publicly accessible. Thus, determining the certifications granted to users typically requires contacting multiple certification authorities and/or consulting multiple different databases. Also, users often times have difficulty deciding which certification to obtain next given their career/professional goals, as they have limited information regarding the sequence of certifications obtained by other users who have reached those career/professional goal.

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 is a block diagram of system in which records of certifications granted to users can be stored in a distributed ledger implemented by a peer-to-peer computer network, according to some implementations.

FIG. 2 is a block diagram illustrating token transfers between digital wallets, according to some implementations.

FIG. 3 is a diagram of a graphical user interface for displaying the most common certifications granted to users after a given certification was granted to those users, according to some implementations.

FIG. 4 is a diagram of a graphical user interface for displaying the most common certifications granted to users having a given job type, according to some implementations.

FIG. 5 is a diagram illustrating a graphical user interface for displaying a job readiness score, according to some implementations.

FIG. 6 is a flow diagram of a process for recording certifications granted to users in a distributed ledger implemented in a peer-to-peer computer network, according to some implementations.

FIG. 7 is a flow diagram of a process for analyzing records of certifications granted to users in a distributed ledger implemented in a peer-to-peer computer network, according to some implementations.

FIG. 8 is a block diagram illustrating an electronic device 800, according to some implementations.

### DETAILED DESCRIPTION

The following description describes systems, methods, and apparatus for recording certifications granted to users in a distributed ledger implemented in a peer-to-peer computer network.

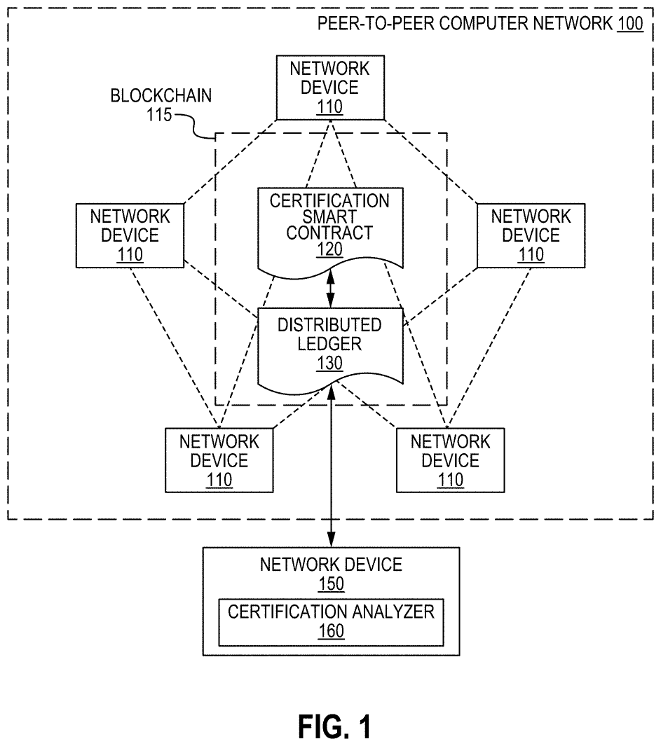

FIG. 1 is a block diagram of system in which records of certifications granted to users can be stored in a distributed ledger implemented by a peer-to-peer computer network, according to some implementations. As shown in the diagram, the system includes multiple network devices 110 communicatively coupled to each other that collectively form a peer-to-peer computer network 100. The network devices 110 in the peer-to-peer computer network 100 may implement a certification smart contract 120 and a distributed ledger 130 using a blockchain 115. In one implementation, the blockchain 115 is an Ethereum blockchain and the certification smart contract 120 is an Ethereum smart contract.

As mentioned above, certification authorities may grant certifications to users, for example, if a user completes a particular course and/or passes a particular examination. As used herein, unless the context indicates otherwise, the term “user” refers to an entity (e.g., an individual person) that can be granted one or more certifications. Examples of certification authorities include SALESFORCE®, AMAZON® (e.g., granting Amazon Web Services (AWS) certifications), ALEXOS (e.g., granting Information Technology Infrastructure Library (ITIL) certifications), the International Information System Security Certification Consortium (ISC) (e.g., granting Certified Information Systems Security Professional (CISSP) certifications), Information Systems Audit and Control Association (ISACA) (e.g., granting Certified Information Systems Auditor (CISA) certifications), and various academic institutions such as universities (e.g., granting degrees/certifications). In one implementation, certification authorities record certifications granted to users in the distributed ledger 130 in the form of token transfers. The tokens may be any form of digital currency. For example, in an implementation, the tokens are Ethereum Request for Comments 20 (ERC20) compliant tokens. In one implementation, each certification and user is associated with a digital wallet that can be used to transfer tokens. In one implementation, each digital wallet may be a cryptocurrency digital wallet that is identifiable using an identifier (e.g., a public key or derived from the public key) that is linked to a private key. This allows anyone who knows the identifier of a digital wallet to transfer tokens to that digital wallet while ensuring tokens can only be transferred out of a digital wallet by someone who knows the private key of that digital wallet (e.g., the certification authority).

In one implementation, when a certification authority grants a certification to a user, the certification authority transfers a token from the digital wallet associated with the certification to the digital wallet associated with the user. This token transfer is recorded in the distributed ledger 130 to indicate that the certification has been granted to the user. In addition, the certification authority that granted the user's previous (most recently obtained) certification (which may be the same certification authority or a different certification authority from the certification authority that granted the current certification to the user) may transfer a token from the digital wallet associated with the previous certification to the digital wallet associated with the current certification. This token transfer is recorded in the distributed ledger 130 to indicate that the current certification was granted to the user after the previous certification was granted to the user. In one implementation, such token transfers (between digital wallets associated with different certifications) are made for certifications granted by the same certification authority as well as for certifications granted for different certification authorities to create an “internal only” (i.e., internal to the certification authority) link/path and an “external also” link/path. The distributed ledger 130 may thus include (1) records of token transfers between digital wallets associated with certifications and digital wallets associated with users that indicate the certifications granted to those users; and (2) records of token transfers between digital wallets associated with different certifications that indicate the certifications that were granted to users after a given certification was granted to those users.

In one implementation, the certification smart contract 120 is configured to automatically perform the token transfers mentioned above. A smart contract is computer code (which can be stored using a blockchain) configured with a set of rules under which the parties to that smart contract agree to interact with each other. If and when the pre-defined rules are met, the agreement is automatically enforced. Smart contracts facilitate, verify, and enforce the negotiation or performance of an agreement or transaction. For example, the certification smart contract 120 may be configured to detect when a certification authority has granted a certification to a user and in response to detecting that the certification has been granted to the user, cause a token to be transferred from the digital wallet associated with the certification to the digital wallet associated with the user and also cause a token to be transferred from the digital wallet associated with the previous certification granted to the user to the digital wallet associated with the current certification.

In one implementation, the system further includes network device 150 that has access to the distributed ledger 130. In one implementation, network device 150 includes a certification analyzer 160. The certification analyzer 160 may determine various useful/insightful information regarding certifications based on analyzing the records stored in the distributed ledger 130. For example, as will be described in additional detail below, the certification analyzer 160 may determine the most common certifications that were granted to users after being granted a given certification, the most common certifications granted to users having a given job type, and/or a job readiness score for a user with respect to a given job type. While network device 150 is shown in the diagram as being outside of the peer-to-peer computer network 100, in some implementations network device 150 may be part of the peer-to-peer computer network 100.

In one implementation, the certification analyzer 160 determines the most common certifications that were granted to users (information regarding the names of the certifications may be stored in the distributed ledger 130 itself or in a separate data store (e.g., as a mapping of digital wallet identifiers (associated with certifications) to certification names)) after being granted a given certification by determining the most common certifications that the given certification transferred tokens to (e.g., based on inspecting the distributed ledger 130 for token transfers made from the digital wallet associated with the given certification to digital wallets associated with other certifications).

In one implementation, the certification analyzer 160 determines the most common certifications granted to users having a given job type by determining which users have the given job type (information regarding the job types of users may be stored in the distributed ledger 130 itself or in a separate data store (e.g., as a mapping of digital wallet identifiers (associated with users) to job types)) and determining the most common certifications that transferred tokens to the users having the given job type (e.g., based on inspecting the distributed ledger 130 for token transfers made from digital wallets associated with certifications to the digital wallet associated with users having the given job type).

In one implementation, the certification analyzer 160 determines a job readiness score for a user with respect to a given job type by assigning a weight/value to each certification granted to users having the given job type and subtracting that weight/value from the user's job readiness score if the user has not been granted that certification. The job readiness score is a score/value that indicates how ready a user is for a given job type based on the certifications that have been granted to that user. For example, assume that the maximum job readiness score is 100 percent. Each certification is assigned a weight/value, where the weight/value is given as N_{c}/Nₜ, where N_{c} is the number of that particular certification that has been granted to users having the given job type and Nₜ is the total number of certifications granted to users having the given type. The job readiness score may then be calculated by subtracting (e.g., from the maximum job readiness score of 100%) the weights/values of the certifications that the user has not been granted. Thus, if the user has not been granted a certification that has been granted to most users having the given job type, then this will negatively impact the user's job readiness score more than if the user has not been granted a certification that has been granted to only a few of the users having the given job type.

Various implementations described herein provide several advantages over existing solutions for recording certifications granted to users. The use of the distributed ledger 130 allows multiple different certification authorities to record the certifications it has granted to users without involving a central authority. Also, storing the distributed ledger 130 using a blockchain ensures the security and integrity of the records. Also, storing records of the certifications granted to users after being granted a given certification allows for providing useful/insightful information to users such as the most common certifications granted to users after being granted a given certification, the most common certifications granted to users having a given job type, and/or job readiness scores for users with respect to a given job type, which may help users decide which certifications to obtain next.

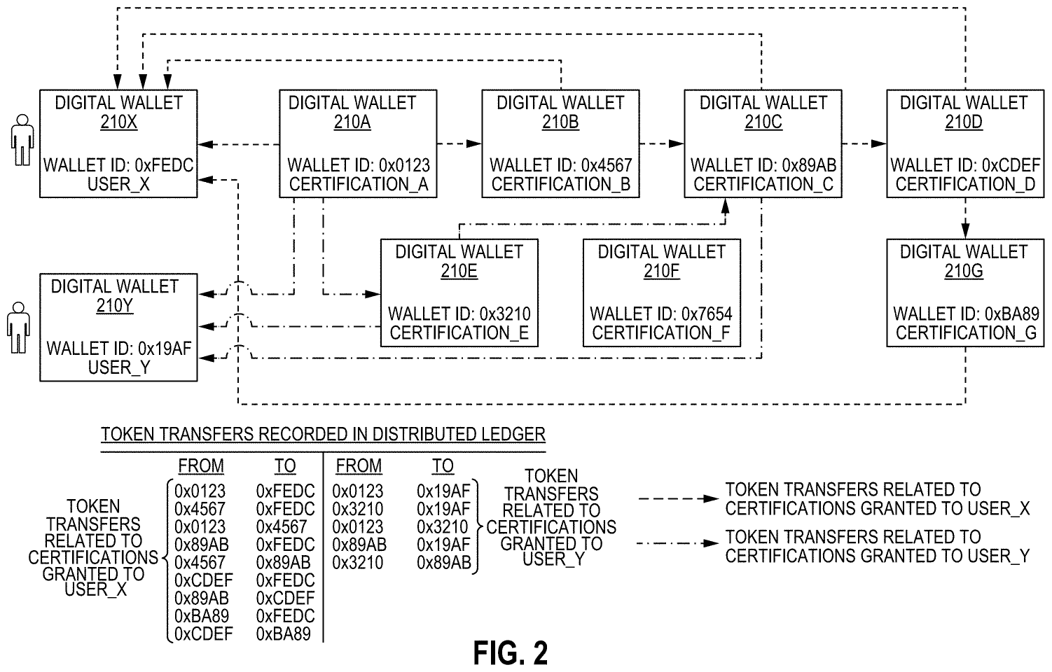

FIG. 2 is a block diagram illustrating token transfers between digital wallets, according to some implementations. As shown in the diagram, each user is associated with a digital wallet 210. In this example, USER_X is associated with digital wallet 210X having wallet ID 0xFEDC and USER_Y is associated with digital wallet 210Y having wallet ID 0x19AF. Also, each certification is associated with a digital wallet 210. In this example, CERTIFICATION_A is associated with digital wallet 210A having wallet ID 0x0123, CERTIFICATION_B is associated with digital wallet 210B having wallet ID 0x4567, CERTIFICATION_C is associated with digital wallet 210C having wallet ID 0x89AB, CERTIFICATION_D is associated with digital wallet 210D having wallet ID 0xCDEF, CERTIFICATION_E is associated with digital wallet 210E having wallet ID 0x3210, CERTIFICATION_F is associated with digital wallet 210F having wallet ID 0x7654, and CERTIFICATION_G is associated with digital wallet 210G having wallet ID 0XBA89.

In this example, it is assumed that USER_X has been granted CERTIFICATION_A, CERTIFICATION_B, CERTIFICATION_C, CERTIFICATION_D, AND CERTIFICATION_G in that order while USER_Y has been granted CERTIFCIATION A, CERTIFICATION_E, AND CERTIFICATION_C in that order. When USER_X is granted CERTIFICATION_A, a token is transferred from digital wallet 210A (the digital wallet associated with CERTIFICATION_A) to digital wallet 210X (the digital wallet associated with USER_X) and this token transfer is recorded in the distributed ledger 130 (from 0x0123 to 0xFEDC) to indicate that CERTIFICATION_A has been granted to USER_X. When USER_X is granted CERTIFICATION_B, a token is transferred from digital wallet 210B (the digital wallet associated with CERTIFICATION_B) to digital wallet 210X (the digital wallet associated with USER_X) and this token transfer is recorded in the distributed ledger 130 (from 0x4567 to 0xFEDC) to indicate that CERTIFICATION_B has been granted to USER_X. In addition, a token is transferred from digital wallet 210A (the digital wallet associated with CERTIFICATION_A) to digital wallet 210B (the digital wallet associated with CERTIFICATION_B) and this token transfer is recorded in the distributed ledger 130 (from 0x0123 to 0x4567) to indicate that a user was granted CERTIFICATION_B after being granted CERTIFICATION_A. Similarly, when USER_X is granted CERTIFICATION_C, a token is transferred from digital wallet 210C (the digital wallet associated with CERTIFICATION_C) to digital wallet 210X (the digital wallet associated with USER_X) and this token transfer is recorded in the distributed ledger 130 (from 0x89AB to 0xFEDC) to indicate that CERTIFICATION_C has been granted to USER_X. In addition, a token is transferred from digital wallet 210B (the digital wallet associated with CERTIFICATION_B) to digital wallet 210C (the digital wallet associated with CERTIFICATION_C) and this token transfer is recorded in the distributed ledger 130 (from 0x04567 to 0x89AB) to indicate that a user was granted CERTIFICATION_C after being granted CERTIFICATION_B. Similarly, when USER_X is granted CERTIFICATION_D, a token is transferred from digital wallet 210D (the digital wallet associated with CERTIFICATION_D) to digital wallet 210X (the digital wallet associated with USER_X) and this token transfer is recorded in the distributed ledger 130 (from 0xCDEF to 0xFEDC) to indicate that CERTIFICATION_D has been granted to USER_X. In addition, a token is transferred from digital wallet 210C (the digital wallet associated with CERTIFICATION_C) to digital wallet 210D (the digital wallet associated with CERTIFICATION_D) and this token transfer is recorded in the distributed ledger 130 (from 0x89AB to 0xCDEF) to indicate that a user was granted CERTIFICATION_D after being granted CERTIFICATION_C. Similarly, when USER_X is granted CERTIFICATION_G, a token is transferred from digital wallet 210G (the digital wallet associated with CERTIFICATION_G) to digital wallet 210X (the digital wallet associated with USER_X) and this token transfer is recorded in the distributed ledger 130 (from 0xBA89 to 0xFEDC) to indicate that CERTIFICATION_G has been granted to USER_X. In addition, a token is transferred from digital wallet 210D (the digital wallet associated with CERTIFICATION_D) to digital wallet 210G (the digital wallet associated with CERTIFICATION_G) and this token transfer is recorded in the distributed ledger 130 (from 0x0CDEF to 0xBA89) to indicate that a user was granted CERTIFICATION_G after being granted CERTIFICATION_C. The token transfers related to the certifications granted to USER_Y are visually represented in the diagram using dashed arrows.

In a similar manner, when USER_Y is granted CERTIFICATION_A, a token is transferred from digital wallet 210A (the digital wallet associated with CERTIFICATION_A) to digital wallet 210Y (the digital wallet associated with USER_Y) and this token transfer is recorded in the distributed ledger 130 (from 0x0123 to 0x19AF) to indicate that CERTIFICATION_A has been granted to USER_Y. When USER_Y is granted CERTIFICATION_E, a token is transferred from digital wallet 210E (the digital wallet associated with CERTIFICATION_E) to digital wallet 210Y (the digital wallet associated with USER_Y) and this token transfer is recorded in the distributed ledger 130 (from 0x3210 to 0x19AF) to indicate that CERTIFICATION_E has been granted to USER_Y. In addition, a token is transferred from digital wallet 210A (the digital wallet associated with CERTIFICATION_A) to digital wallet 210E (the digital wallet associated with CERTIFICATION_E) and this token transfer is recorded in the distributed ledger 130 (from 0x0123 to 0x3210) to indicate that a user was granted CERTIFICATION_E after being granted CERTIFICATION_A. Similarly, when USER_Y is granted CERTIFICATION_C, a token is transferred from digital wallet 210C (the digital wallet associated with CERTIFICATION_C) to digital wallet 210Y (the digital wallet associated with USER_Y) and this token transfer is recorded in the distributed ledger 130 (from 0x89AB to 0x19AF) to indicate that CERTIFICATION_C has been granted to USER_Y. In addition, a token is transferred from digital wallet 210E (the digital wallet associated with CERTIFICATION_E) to digital wallet 210C (the digital wallet associated with CERTIFICATION_C) and this token transfer is recorded in the distributed ledger 130 (from 0x3210 to 0x89AB) to indicate that a user was granted CERTIFICATION_C after being granted CERTIFICATION_E. The token transfers related to the certifications granted to USER_Y are visually represented in the diagram using dash dotted arrows. It should be noted that in this example CERTIFICATION_F has not been granted to USER_X or USER_Y and thus the digital wallet 210F associated with CERTIFICATION_F is not involved in any token transfers.

The certifications granted to a given user (e.g., USER_X or USER_Y) may be determined based on inspecting the distributed ledger 130 for token transfers made from the digital wallets associated with certifications to the digital wallet associated with that user. The certifications granted to users after being granted a given certification can be determined based on inspecting the distributed ledger 130 for token transfers made from the digital wallet associated with that given certification to the digital wallet(s) associated with other certification(s).

While various implementations have been described where tokens are transferred in a specific direction, it should be understood that this is by way of example and not intended to be limiting, and that other implementations may transfer tokens in the reverse direction. For example, when a certification authority grants a certification to a user, a token may be transferred from the digital wallet associated with the user to the digital wallet associated with the certification to indicate that the certification has been granted to the user. Similarly, in one implementation, a token may be transferred from the digital wallet associated with the certification to the digital wallet associated with the previous (most recent) certification granted to the user to indicate that the certification was granted to the user after the previous certification was granted to the user.

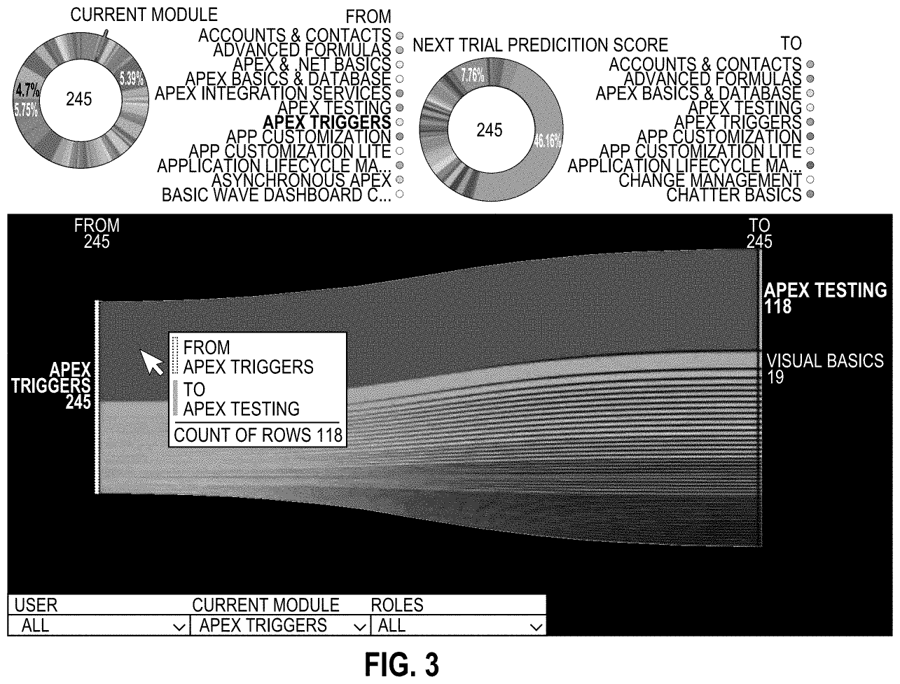

FIG. 3 is a diagram of a graphical user interface for displaying the most common certifications granted to users after a given certification was granted to those users, according to some implementations. In this example, the graphical user interface displays the most common certifications granted to users after being granted the “apex triggers” module certification. In one implementation, this information is determined by a certification analyzer 160 based on analyzing records stored in a distributed ledger 130 as descried above. The graphical user interface includes a donut chart in the top-right portion of the interface that visually depicts the most common certifications granted to users after being granted the “apex triggers” module certification. In this example, the donut chart indicates that there are 245 users that have been granted to the “apex triggers” module certification and that the most common certification granted to users after being granted the “apex triggers” module certification is the “apex testing” module certification (with 48.16% of users being granted the “apex testing” module certification after being granted the “apex triggers” module certification). The “wave bar” graph to the bottom of the donut chart visually depicts similar information in a different format. The left side of the wave bar graph indicates that 245 users have been granted the “apex triggers” module certification. Each horizontal wave bar in the graph indicates the next certification granted to users after being granted the “apex triggers” module certification. The thickness of the wave bar represents the number (or percentage) of users that were granted the corresponding certification. For example, the topmost wave bar (the thickest wave bar) in the graph indicates that the “apex testing” module certification is the most common next certification with 118 out of 245 users being granted this certification after being granted the “apex triggers” module certification, while the next “wave bar” (just below the “apex testing” module certification wave bar) indicates that the “visualforce basics” module certification is the next most common next certification with 19 out of 245 users being granted this certification after being granted the “apex triggers” module certification.

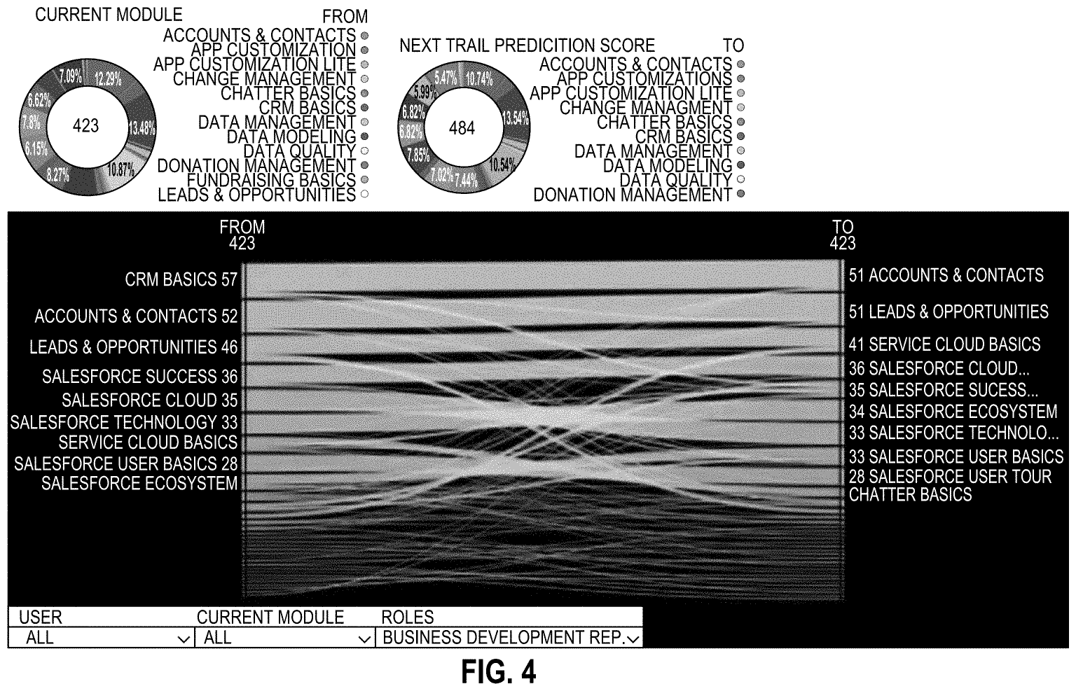

FIG. 4 is a diagram of a graphical user interface for displaying the most common certifications granted to users having a given job type, according to some implementations. In this example, the graphical user interface displays the most common certifications granted to users having a business development representative job type. In one implementation, this information is determined by a certification analyzer 160 based on analyzing records stored in a distributed ledger 130 as descried above. The top portion of the graphical user interface includes donut charts that visually depict the most common certifications granted to users having the business development representative job type. In this example, the donut charts (e.g., the donut chart on the left) indicate that 423 certifications have been granted to users having the business development representative job type (before those users were granted another certification (i.e., “from” certifications) and that the most common of these certifications is the “crm basics” module certification (13.48% of certifications). Also, the donut charts (e.g., the donut chart on the right) indicate that 484 certifications have been granted to users having the business development representative job type (“to” certifications). The “wave bar” graph to the bottom of this donut chart visually depicts similar information in a different format. The left side of the wave bar graph indicates that 423 certifications have been granted users have the business development representative job type (before those users were granted another certification) and that the most common of these certifications are the “crm basics” module certification (with 57 out of 423 certifications), followed by the “accounts and contacts” module certification (with 52 out of 423 certifications), the “leads and opportunities” module certification (with 46 out of 423 certifications), and so on. Also, the right side of the wave bar graph indicates that the most common certifications granted to users having the business development representative job type after being granted the certifications on the left side of the graph are the “accounts and contacts” module certification (with 51 out of 423 certifications), the “leads and opportunities” module certification (with 51 out of 423 certifications), the “service cloud basics” module certification (with 41 out of 423 certifications), and so on.

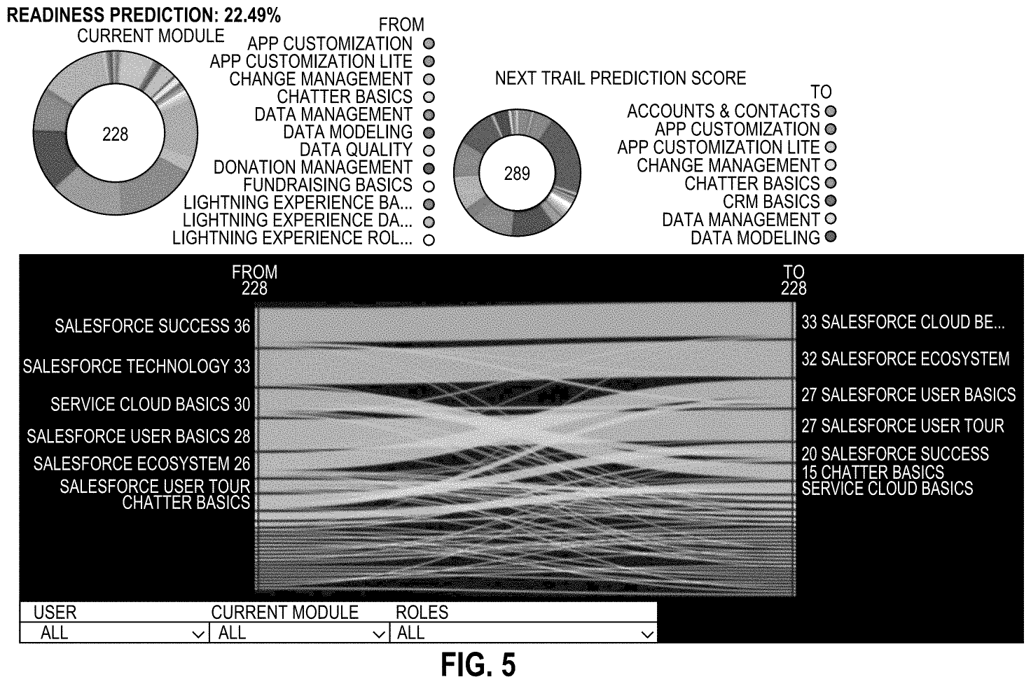

FIG. 5 is a diagram illustrating a graphical user interface for displaying a job readiness score, according to some implementations. In this example, the graphical user interface indicates that the job readiness score (“readiness prediction”) for a user with respect to the business development representative job type is 22.49%. In one implementation, the job readiness score is determined by a certification analyzer 160 based on analyzing records stored in a distributed ledger 130 as descried above. Also, the graphical user interface includes graphs that visually depict the certifications granted to users having the business development representative job type that have not been granted to a particular user. Based on this information, the user may decide which certifications to obtain next to be better prepared for the business development representative job type.

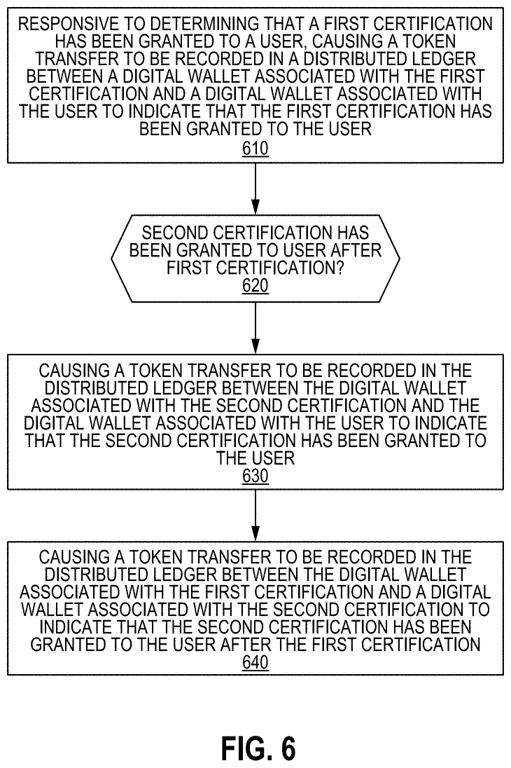

FIG. 6 is a flow diagram of a process for recording certifications granted to users in a distributed ledger implemented in a peer-to-peer computer network, according to some implementations. In one implementation, the process is performed by one or more network devices 110 in a peer-to-peer computer network 100 (e.g., based on executing a certification smart contract 120).

In one implementation, the process is initiated when the network device determines that a first certification has been granted to a user. At block 610, responsive to determining that a first certification has been granted to the user, the network device causes a token transfer to be recorded in a distributed ledger between a digital wallet associated with the first certification and a digital wallet associated with the user to indicate that the first certification has been granted to the user. At block 620, the network device determines whether a second certification has been granted to the user after the first certification has been granted to the user. If not, then the network device may wait until it determines that a second certification has been granted to the user. However, if the network device determines that a second certification has been granted to the user, then the network device causes a token transfer to be recorded in the distributed ledger between the digital wallet associated with the second certification and the digital wallet associated with the user to indicate that the second certification has been granted to the user. Also, at block 640, the network device causes a token transfer to be recorded in the distributed ledger between the digital wallet associated with the first certification and a digital wallet associated with the second certification to indicate that the second certification has been granted to the user after the first certification has been granted to the user.

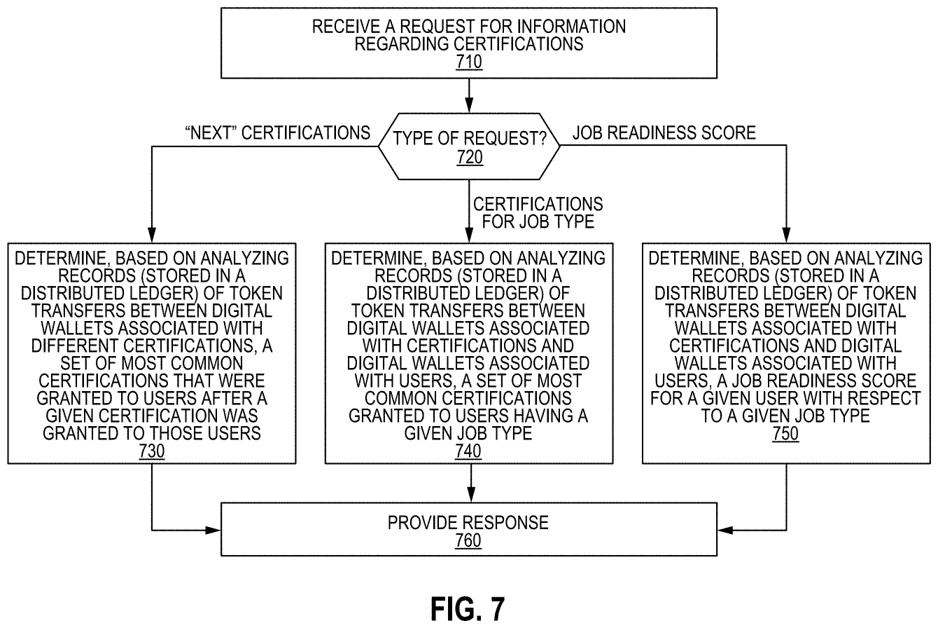

In one implementation, the distributed ledger includes records of token transfers between digital wallets associated with certifications and digital wallets associated with users that indicate which certifications were granted to which users and also includes records of token transfers between digital wallets associated with different certifications that indicate which certifications were granted to users after a given certification was granted to those users (e.g., based on operations similar to those of blocks 610-640 being performed for certifications granted to multiple users). As will be further described with reference to FIG. 7, these records may be analyzed to determine useful/insightful information such as the set of most common certifications that were granted to users after a given certification was granted to those users, the set of most common certifications granted to users having a given job type, and a job readiness score for a given user with respect to a given job type.

In one implementation, the first certification and the second certification are granted by different certification authorities. In one implementation, the distributed ledger is stored using a blockchain. In such an implementation, each of the digital wallet associated with the first certification, the digital wallet associated with the second certification, and the digital wallet associated with the user may be assigned an identifier that is linked to a private cryptographic key of that digital wallet and the token transfers are recorded in the distributed ledger using the identifiers.

FIG. 7 is a flow diagram of a process for analyzing records of certifications granted to users in a distributed ledger implemented in a peer-to-peer computer network, according to some implementations. In one implementation, the process is performed by a network device 150 (implementing a certification analyzer 160).

In one implementation, the process is initiated at block 710 when the network device receives a request for information regarding certifications. At decision block 720, the network device determines the type of request. If the request is for the most common “next” certifications granted to users after a given certification was granted to those users (a “next” certifications type request), then at block 730, the network device determines, based on analyzing records (stored in a distributed ledger) of token transfers between digital wallets associated with different certifications, a set of most common certifications that were granted to users after the given certification was granted to those users. Returning to decision block 720, if the request is for the most common certifications granted to users having a given job type, then at block 740, the network determines, based on analyzing records (stored in a distributed ledger) of token transfers between digital wallets associated with certifications and digital wallets associated with users, a set of most common certifications granted to users having the given job type. Returning to decision block 720, if the request is for a job readiness score, then at block 750, the network device determines, based on analyzing records (stored in a distributed ledger) of token transfers between digital wallets associated with certifications and digital wallets associated with users, a job readiness score for a given user with respect to a given job type. In one implementation, at block 760, the network device provides a response to the request (e.g., the result of the operations in blocks 730, 740, or 750). In one implementation, the result is provided in the form of a graphical user interface such as the ones shows in FIGS. 3-5.

One or more parts of the above implementations may include software and/or a combination of software and hardware. An electronic device (also referred to as a computing device, computer, etc.) includes hardware and software, such as a set of one or more processors coupled to one or more machine-readable storage media (e.g., magnetic disks, optical disks, read only memory (ROM), Flash memory, phase change memory, solid state drives (SSDs)) to store code (which is composed of software instructions and which is sometimes referred to as computer program code or a computer program) for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device is turned off, and that has sufficiently fast read/write times such that, rather than copying the part of the code/data to be executed into volatile memory, the code/data may be provided directly to the set of processors (e.g., loaded into a cache of the set of processors); in other words, this non-volatile memory operates as both long term storage and main memory, and thus the electronic device may have no or only a small amount of volatile memory for main memory. In addition to storing code and/or data on machine-readable storage media, typical electronic devices can transmit code and/or data over one or more machine-readable transmission media (also called a carrier) (e.g., electrical, optical, radio, acoustical or other form of propagated signals—such as carrier waves, infrared signals). For instance, typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network) code and/or data with one or more machine-readable media (also referred to as computer-readable media).

Electronic devices are used for a variety of purposes. For example, an electronic device (sometimes referred to as a server electronic device) may execute code that cause it to operate as one or more servers used to provide a service to another electronic device(s) (sometimes referred to as a client electronic device, a client computing device, or a client device) that executes client software (sometimes referred to as client code or an end user client) to communicate with the service. The server and client electronic devices may be operated by users respectively in the roles of administrator (also known as an administrative user) and end user.

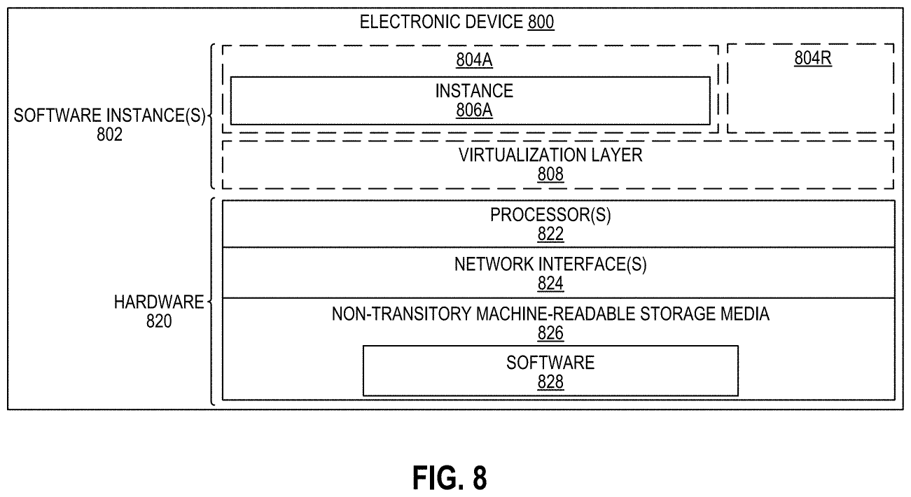

FIG. 8 is a block diagram illustrating an electronic device 800, according to some implementations. FIG. 8 includes hardware 820 comprising a set of one or more processor(s) 822, a set of one or more network interfaces 824 (wireless and/or wired), and non-transitory machine-readable storage media 826 having stored therein software 828 (which includes instructions executable by the set of one or more processor(s) 822). Each of the previously described functionalities (e.g., those related to recording certifications granted to users (and the certifications granted to users after a given certification has been granted to those users) in a distributed ledger and analyzing records stored in a distributed ledger) may be implemented in one or more electronic devices 800.

In electronic devices that use compute virtualization, the set of one or more processor(s) 822 typically execute software to instantiate a virtualization layer 808 and software container(s) 804A-R (e.g., with operating system-level virtualization, the virtualization layer 808 represents the kernel of an operating system (or a shim executing on a base operating system) that allows for the creation of multiple software containers 804A-R (representing separate user space instances and also called virtualization engines, virtual private servers, or jails) that may each be used to execute a set of one or more applications; with full virtualization, the virtualization layer 808 represents a hypervisor (sometimes referred to as a virtual machine monitor (VMM)) or a hypervisor executing on top of a host operating system, and the software containers 804A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 828 (illustrated as instance 806A) is executed within the software container 804A on the virtualization layer 808. In electronic devices where compute virtualization is not used, the instance 806A on top of a host operating system is executed on the “bare metal” electronic device 800. The instantiation of the instance 806A, as well as the virtualization layer 808 and software containers 804A-R if implemented, are collectively referred to as software instance(s) 802.

Alternative implementations of an electronic device may have numerous variations from that described above. For example, customized hardware and/or accelerators might also be used in an electronic device.

A network device (ND) is an electronic device that communicatively interconnects other electronic devices on the network (e.g., other network devices, user electronic devices, server electronic devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

In the above description, numerous specific details such as resource partitioning/sharing/duplication implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are be described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

While the above description includes several exemplary implementations, those skilled in the art will recognize that the invention is not limited to the implementations described and can be practiced with modification and alteration within the spirit and scope of the appended claims. The description is thus illustrative instead of limiting.

What is claimed is:

1. A method by one or more network devices to record certifications granted to users in a distributed ledger implemented by a peer-to-peer computer network, the method comprising:
responsive to determining that a first certification has been granted to a user, causing a token transfer to be recorded in the distributed ledger between a digital wallet associated with the first certification and a digital wallet associated with the user to indicate that the first certification has been granted to the user; and
responsive to determining that a second certification has been granted to the user after the first certification has been granted to the user, causing a token transfer to be recorded in the distributed ledger between a digital wallet associated with the second certification and the digital wallet associated with the user to indicate that the second certification has been granted to the user and also causing a token transfer to be recorded in the distributed ledger between the digital wallet associated with the first certification and the digital wallet associated with the second certification to indicate that the second certification has been granted to the user after the first certification.

2. The method of claim 1, wherein the distributed ledger includes records of token transfers between digital wallets associated with certifications and digital wallets associated with users that indicate which certifications were granted to which users, and wherein the distributed ledger further includes records of token transfers between digital wallets associated with different certifications that indicate which certifications were granted to users after a given certification was granted to those users.

3. The method of claim 2, further comprising:
determining, based on analyzing the records of token transfers stored in the distributed ledger between digital wallets associated with different certifications, a set of most common certifications that were granted to users after a given certification was granted to those users.

4. The method of claim 2, further comprising:
determining, based on analyzing the records of token transfers stored in the distributed ledger between digital wallets associated with certifications and digital wallets associated with users, a set of most common certifications granted to users having a given job type.

5. The method of claim 2, further comprising:
determining, based on analyzing the records of token transfers stored in the distributed ledger between digital wallets associated with certifications and digital wallets associated with users, a job readiness score for a given user with respect to a given job type.

6. The method of claim 1, wherein the first certification and the second certification are granted by different certification authorities.

7. The method of claim 1, wherein the distributed ledger is stored using a blockchain.

8. The method of claim 7, wherein each of the digital wallet associated with the first certification, the digital wallet associated with the second certification, and the digital wallet associated with the user is assigned an identifier that is linked to a private cryptographic key of that digital wallet, and wherein token transfers are recorded in the distributed ledger using the identifiers.

9. A non-transitory machine-readable storage medium storing instructions that, when executed by a processor, causes said processor to perform operations for recording certifications granted to users in a distributed ledger implemented by a peer-to-peer computer network, the operations comprising:
responsive to determining that a first certification has been granted to a user, causing a token transfer to be recorded in the distributed ledger between a digital wallet associated with the first certification and a digital wallet associated with the user to indicate that the first certification has been granted to the user; and
responsive to determining that a second certification has been granted to the user after the first certification has been granted to the user, causing a token transfer to be recorded in the distributed ledger between a digital wallet associated with the second certification and the digital wallet associated with the user to indicate that the second certification has been granted to the user and also causing a token transfer to be recorded in the distributed ledger between the digital wallet associated with the first certification and the digital wallet associated with the second certification to indicate that the second certification has been granted to the user after the first certification.

10. The non-transitory machine-readable storage medium of claim 9, wherein the distributed ledger is to include records of token transfers between digital wallets associated with certifications and digital wallets associated with users that indicate which certifications were granted to which users, and wherein the distributed ledger further includes records of token transfers between digital wallets associated with different certifications that indicate which certifications were granted to users after a given certification was granted to those users.

11. The non-transitory machine-readable storage medium of claim 10, wherein the operations further comprise:
determining, based on analyzing the records of token transfers stored in the distributed ledger between digital wallets associated with different certifications, a set of most common certifications that were granted to users after a given certification was granted to those users.

12. The non-transitory machine-readable storage medium of claim 10, wherein the operations further comprise:
determining, based on analyzing the records of token transfers stored in the distributed ledger between digital wallets associated with certifications and digital wallets associated with users, a set of most common certifications granted to users having a given job type.

13. The non-transitory machine-readable storage medium of claim 10, wherein the operations further comprise:
determining, based on analyzing the records of token transfers stored in the distributed ledger between digital wallets associated with certifications and digital wallets associated with users, a job readiness score for a given user with respect to a given job type.

14. The non-transitory machine-readable storage medium of claim 9, wherein the first certification and the second certification are granted by different certification authorities.

15. A network device configured to record certifications granted to users in a distributed ledger implemented by a peer-to-peer computer network, the network device comprising:
one or more processors; and
a non-transitory machine-readable storage medium having instructions stored therein, which when executed by the one or more processors, causes the network device to:
responsive to determining that a first certification has been granted to a user, cause a token transfer to be recorded in the distributed ledger between a digital wallet associated with the first certification and a digital wallet associated with the user to indicate that the first certification has been granted to the user; and
responsive to determining that a second certification has been granted to the user after the first certification has been granted to the user, cause a token transfer to be recorded in the distributed ledger between a digital wallet associated with the second certification and the digital wallet associated with the user to indicate that the second certification has been granted to the user and also cause a token transfer to be recorded in the distributed ledger between the digital wallet associated with the first certification and the digital wallet associated with the second certification to indicate that the second certification has been granted to the user after the first certification.

16. The network device of claim 15, wherein the distributed ledger is to include records of token transfers between digital wallets associated with certifications and digital wallets associated with users that indicate which certifications were granted to which users, and wherein the distributed ledger further includes records of token transfers between digital wallets associated with different certifications that indicate which certifications were granted to users after a given certification was granted to those users.

17. The network device of claim 16, wherein the instructions when executed by the one or more processors, further causes the network device to:
determine, based on analyzing the records of token transfers stored in the distributed ledger between digital wallets associated with different certifications, a set of most common certifications that were granted to users after a given certification was granted to those users.

18. The network device of claim 16, wherein the instructions when executed by the one or more processors, further causes the network device to:
determine, based on analyzing the records of token transfers stored in the distributed ledger between digital wallets associated with certifications and digital wallets associated with users, a set of most common certifications granted to users having a given job type.

19. The network device of claim 16, wherein the instructions when executed by the one or more processors, further causes the network device to:
determine, based on analyzing the records of token transfers stored in the distributed ledger between digital wallets associated with certifications and digital wallets associated with users, a job readiness score for a given user with respect to a given job type.

20. The network device of claim 15, wherein the distributed ledger is stored using a blockchain.
